(19) United States
(12) Patent Application Publication
(10) Pub. No.: US 2014/0364118 A1
(43) Pub. Date: Dec. 11, 2014

(54) Method and Apparatus for Incoming Call Detection in a Dual SIM Single RF Communication Device

(71) Applicant: Broadcom Corporation, Irvine, CA (US)

(72) Inventors: Farouk BELGHOUL, Campbell, CA (US); Dutt Kalapatapu, Santa Clara, CA (US)

(21) Appl. No.: 13/914,502

(22) Filed: Jun. 10, 2013

(51) Int. Cl. H04W 68/00; H04W 76/04; H04W 80/10; H04W 88/06

(52) U.S. Cl. CPC H04W 68/005; H04W 88/06; H04W 76/048; H04W 80/10
USPC 455/435.1

(57) ABSTRACT

A method and apparatus to co-ordinate detection of incoming calls in a multimode dual-SIM single RF chain wireless communications device. Incoming voice over LTE calls cannot be detected by monitoring LTE paging messages. The method and apparatus described detect voice over LTE incoming call SIP signaling in one SIM while also perform paging monitoring for a circuit-switched call in another SIM in the dual-mode dual-SIM communication device. Using a duty cycle that alternates priority between LTE and circuit-switched monitoring ensures that no incoming voice call or text message will be missed.

### BACKGROUND

1. Field

The disclosure relates generally to wireless communications, and specifically to the detection of incoming calls in a multi-mode wireless communication device.

2. Background Art

Modern telecommunications networks and devices offer a wide variety of protocols that have evolved over the past decades. Beginning in 1981 with analog wireless (also known as first generation, or “1G”), new generations of wireless service have regularly appeared to provide the market place with every increasing digital throughputs. In 1992, digital wireless service (second generation or “2G”) emerged, followed by third generation (3G) service in 2001, which provided multimedia and data support. The year 2011 saw the emergence of fourth generation (4G) wireless services, which are packet networks. Although 4G services are now routinely available, 2G and 3G wireless continue to be available. In fact, in certain areas, it is useful that more than one type of wireless service continue to be available to support the modern day demands of the marketplace.

Communication devices connect to modern cellular networks through the use of a SIM (subscriber identity module) card. A SIM card contains an integrated circuit that securely stores the international mobile subscriber identity (IMSI) and the related key used to identify and authenticate subscribers on mobile communication devices (such as mobile phones and computers). Thus, the SIM card is installed in a wireless communications device, and enables the authentication and connection with a particular wireless network provider.

In certain situations, customers desire the ability to access more than one wireless network using a single communications device. For example, a customer may have various voice and data needs that warrant the ability to connect to two or more wireless network services. In such cases, the mobile communications device is provided with two or more SIM connection ports, with each SIM connection port designed to accept a SIM card. Each SIM card thereby provides the device user with the ability to be authenticated and receive services from a different network provider than the other SIM card. Accordingly, the device user can use the different networks for different uses (e.g., voice, SMS services, data), or to have redundancy to provide a higher degree of certainty of communication.

A multi-SIM wireless communications device can have a single RF chain, but still be configured so that it is capable of accessing multiple wireless services. For example, a multi-SIM wireless communications device can monitor multiple instantiations of multiple protocols, e.g., GSM, UMTS and LTE channels. The multi-SIM wireless communications device registers each SIM with its associated network consecutively, and maintains idle network connections for each SIM using separate control channels. Such a configuration enables traffic (e.g., calls, messages and data) to be received on any registered SIM.

Wireless communications devices detect incoming phone calls by monitoring the paging function associated with the protocols involved. For example, in the case of 2G and 3G calls, background paging monitoring can be used for incoming call detection. However, such an approach does not work in the case of Voice over LTE (long term evolution) calls. Voice over LTE (VoLTE) incoming call signaling is not provided by LTE paging messages, but is instead is provided through Session Initiation Protocol (SIP) messages.

### BRIEF SUMMARY

What is needed is an approach for a multi-SIM wireless communications device having a single RF chain to be able to detect both an incoming voice call or text message in a packet-based protocol, e.g., VoLTE, as well as being able to detect an incoming circuit-switched voice call or text message through paging monitoring in the circuit-switched protocol, e.g., a 2G/3G protocol.

One embodiment of the approach includes a method that registers a wireless communications device in a first wireless network using a first SIM, where the wireless communications device has a single RF chain. The method also registers the wireless communications device in a second wireless network using a second SIM, where the second wireless network is a packet network. Finally, the method detects an incoming call for the second wireless network using a duty cycle, where the duty cycle has a first time interval and a second time interval. The detecting includes monitoring the second wireless network for the incoming call during the first time interval while suspending monitoring the second wireless network during the second time interval.

A further embodiment of the approach includes an apparatus that includes one or more circuits that register a wireless communications device in a first wireless network using a first SIM, where the wireless communications device has a single RF chain. The apparatus also registers the wireless communications device in a second wireless network using a second SIM, where the second wireless network is a packet network. Finally, the apparatus detects an incoming call for the second wireless network using a duty cycle, where the duty cycle has a first time interval and a second time interval. The detection includes monitoring the second wireless network for the incoming call during the first time interval while suspending monitoring the second wireless network during the second time interval.

Further embodiments, features, and advantages of the disclosed embodiments, as well as the structure and operation of the various embodiments are described in detail below with reference to the accompanying drawings.

### BRIEF DESCRIPTION OF THE DRAWINGS/FIGURES

The accompanying drawings, which are incorporated herein and form part of the specification, illustrate the disclosed embodiments and, together with the description, further serve to explain the principles of the disclosed embodiments and to enable a person skilled in the relevant art(s) to make and use the disclosed embodiments.

FIG. 1 illustrates a block diagram of an exemplary wireless communication environment.

FIG. 2 illustrates a block diagram of an exemplary wireless communication device that may be used in the wireless communication environment.

FIG. 3 illustrates an exemplary timing diagram of paging monitoring in a circuit-switched protocol using a DRX cycle.

FIG. 4 illustrates the SIP INVITE timing requirements used in a VoLTE environment, in accordance with an embodiment.

FIG. 5 illustrates an exemplary timing diagram of a coordinated circuit-switched paging monitoring procedure for an incoming call, and SIP INVITE monitoring procedure for voice over IP incoming call monitoring, in accordance with an embodiment of the present invention.

FIG. 6 illustrates a flowchart diagram of an exemplary dual-SIM incoming call detection method.

FIG. 7 illustrates a block diagram of an exemplary general purpose computer system.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Wireless communication network deployments continue to evolve as wireless communication network technology advances and new or updated wireless communication protocols are standardized. Circuit switched networks continue to offer voice and message services while packet switched networks provide data oriented services that may include a multiplicity of services including video and packet voice. Wireless communication devices also continue to increase in functionality to supplement voice connections with multimedia internet connectivity. A typical “smart phone” may include wireless circuitry that can communicate over several different types of wireless networks including: short range wireless, such as Bluetooth; medium range wireless, such as WiFi; and long range wireless, such as GSM/GPRS, UMTS, CDMA2000 1x/EV-DO and LTE/LTE-Advanced. Each wireless receiver in a mobile wireless device may consume significant amounts of battery power and occupies a portion of limited board space available inside the mobile wireless device.

A wireless communications device may include a single receiver (or RF chain) through which signals can be received from a first wireless network or from a second wireless network individually, but not simultaneously. In a representative embodiment, the first wireless network can be a 2G/3G wireless network (a circuit switched network) and the second wireless network can be an LTE wireless network (a packet-based network). To notify each wireless network of its presence, the single receiver mobile wireless device can perform an IP Multimedia Subsystem (IMS) registration on the LTE wireless network and can also perform and maintain a simultaneous registration with the 2G/3G wireless network.

### Dual-SIM Single RF Chain Wireless Communication Device

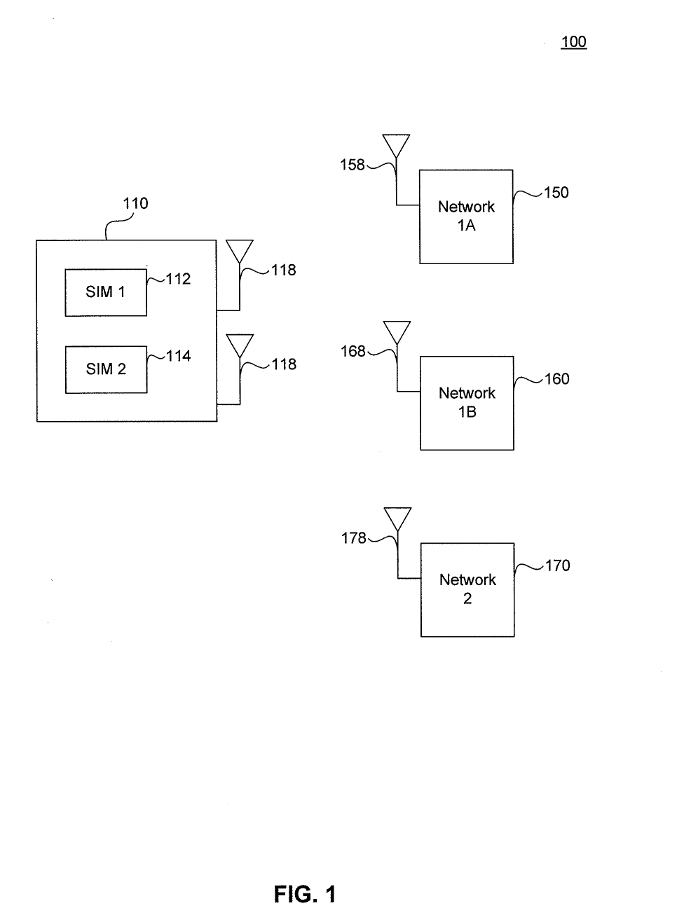

FIG. 1 illustrates a block diagram of an exemplary wireless communication environment 100. The wireless communication environment 100 includes a dual-SIM wireless communication device 110, first network wireless communication devices 150 and 160, and a second network wireless communication device 170.

In the wireless communication environment 100, the dual-SIM wireless communication device 110 communicates with one or more of the network wireless communication devices 150/160/170. The dual-SIM wireless communication device 110 includes a first SIM module 112 and a second SIM module 114 and communicates via one or more antennas 118. In an embodiment, the dual-SIM wireless communication device 110 is a mobile device.

First network wireless communication devices 150 and 160 are capable of providing cellular communication service to the dual-SIM wireless communication device 110 over a first communication network. The first SIM 112 of the dual-SIM wireless communication device 110 will be used to authenticate and communicate with the first network wireless communication devices 150 and 160. In an embodiment, the first network wireless communication devices 150 and 160 are cellular base stations.

A second network wireless communication device 170 is capable of providing cellular communication service to the dual-SIM wireless communication device 110 over a second communication network. The second SIM 114 of the dual-SIM wireless communication device 110 will be used to authenticate and communicate with the second network wireless communication device 170. In an embodiment, the second network wireless communication device 170 is a cellular base station.

Each of the first network wireless communication devices 150 and 160, and the second network wireless communication device 170, communicate with the dual-SIM wireless communication device 110 using one or more antennas 158, 168 and 178, respectively.

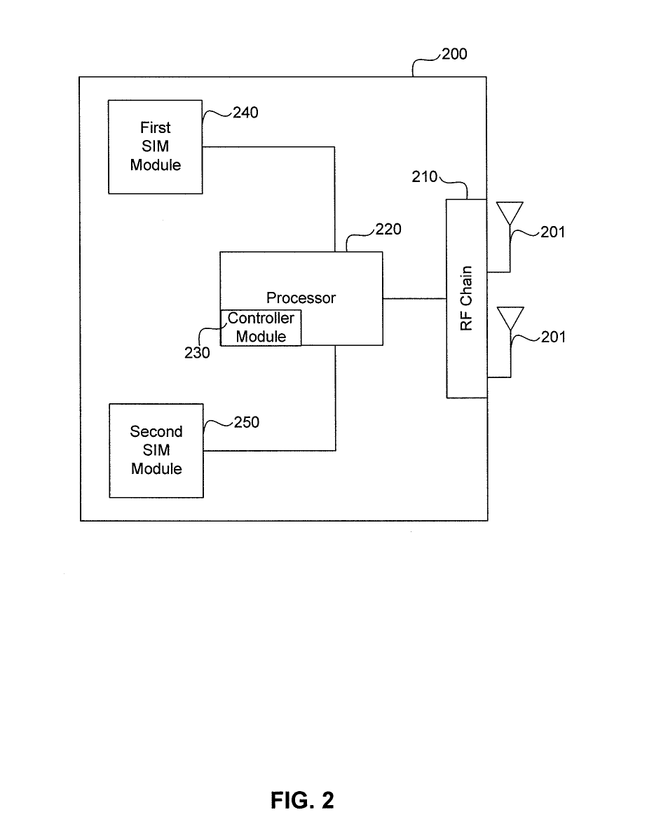

FIG. 2 illustrates a block diagram of an exemplary wireless communication device 200 that may be used in the wireless communication environment 100. The wireless communication device 200 includes a first SIM module 240, a second SIM module 250, and a controller module 230, and may represent an exemplary embodiment of the wireless communication device 110. The first and second SIM modules 240/250 can represent at least a portion of first and second SIM cards that include at least some features according to embodiments of the present disclosure. Controller module 230 controls various functionality in wireless communication device 200, including which of the SIM modules 240/250 is active at any given time.

As shown in FIG. 2, the wireless communication device 200 includes a baseband processor 220 and a single RF chain 210. The RF chain 210 receives wireless signals from a base station in the environment 100 depending on which SIM is currently active, and may include one or more filters, amplifiers, mixers, local oscillator, etc. The baseband processor 220 includes the necessary circuitry for managing the RF chain 210 and signals received thereby. For example, the baseband processor 220 may include one or more of filters, amplifiers, local oscillators, PLLs, demodulators, D/A converters, etc. The baseband processor 220 receives the signals from the RF chain 210 that originated from the environment 100, and processes those signals to be useable by the components of the wireless communication device 200.

When the first SIM module 240 is active, the RF chain 210 receives signals from a first network base station. On the other hand, when the second SIM module 250 is active, the RF chain 210 receives signals from a second network base station. In an embodiment, and for purposes of the discussion below, the first SIM module 240 is associated with circuit-switched data, such as voice and text data, and includes the use of protocols such as 2G and 3G. The second SIM module 250 is associated with packet-switched data, such as internet or streaming data, as well as voice over IP protocols, and includes the use of protocols such as VoLTE.

In a dual-SIM wireless communication device 200, only one SIM can be active at any time due to the single RF chain 210. This can result in some significant issues. For example, one particularly important problem with dual-SIM wireless communication device 200 is that it may monitor for a possible incoming telephone call on the 2G/3G protocols, but miss an incoming telephone call via the voice over IP protocol, such as VoLTE.

### DRX Cycles

In various wireless communication implementations, networks may communicate information to respective wireless communication devices via transmission of messages. For example, paging messages may be transmitted at predefined intervals from networks to wireless communication devices to notify the wireless communication devices of various events. Thus, an idle wireless communication device can be assigned a paging cycle which can be monitored by the wireless communication device at predetermined time slots for possible events. The monitoring by the wireless communications devices may be constant, i.e., without any break in the monitoring. However, this is wasteful of energy since for most of the time, there are no paging messages or other events that occur.

In order to minimize battery consumption and to thereby maximize battery lifetime, wireless communications devices may use a discontinuous reception (DRX) protocol to monitor events of interest, such as paging messages. The DRX protocol may be time aligned with a predetermined cycle so that the wireless communication device knows when the network will transmit events, and when the network will not transmit. Thus, a typical DRX cycle comprises a period when the wireless communication device is in a DRX active mode, followed by a period when the wireless communication device in a DRX sleep mode. When the wireless communications device is in a DRX active mode, it wakes from the DRX sleep mode and monitors the relevant channels for the expected activity, e.g., it monitors for paging signals in the case of 2G/3G protocols, or data transmissions (including SIP messages) in the case of VoLTE in an LTE network. Conversely, when the wireless communications device is in a DRX sleep mode, the wireless communications device does not monitor relevant channels for appropriate activity since it is known a priori that the network does not initiate a transmission during the period. Thus, during periods of the DRX sleep mode, the parts of the wireless communications device that deal with the reception of signals, e.g., the receiver module in the RF chain 210, can be switched off and the wireless communications device can enter a lower power state to thereby save power. Consequently, battery lifetime may be extended through advantageous choices of the relative ratio of the DRX active and DRX sleep periods.

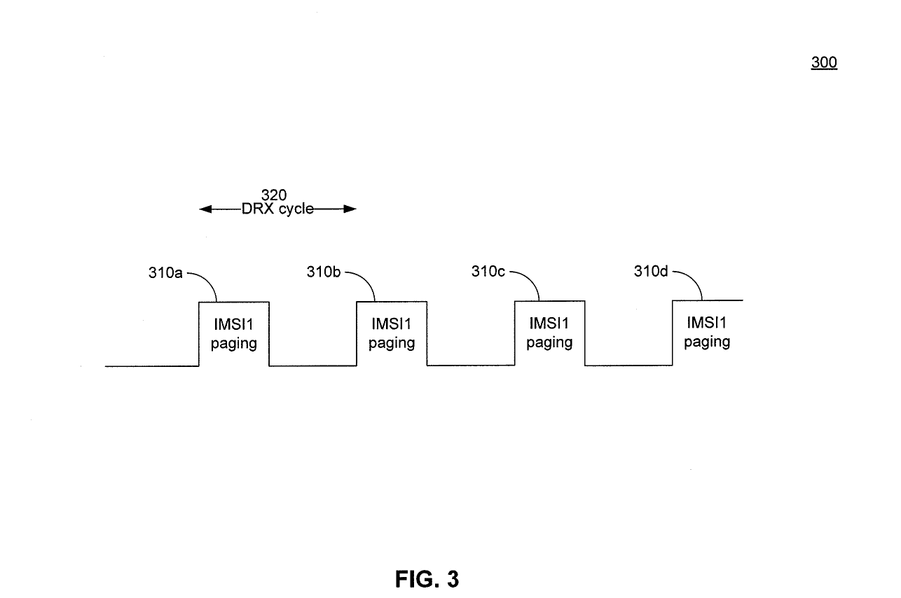

FIG. 3 illustrates an exemplary timing diagram of paging monitoring in a circuit-switched protocol while in the DRX sleep mode. Paging time intervals 310a, 310b, 310c, 310d are the time intervals that are defined for the associated wireless communications device to monitor for possible network events such as paging signals that are transmitted by the network. If a paging signal occurs, then the DRX active mode is extended to accommodate the subsequent network transmissions to the wireless communications device. DRX cycle 320 is synchronized with paging time intervals 310 such that DRX active mode is aligned with paging time intervals 310, while the wireless communications device can switch to DRX sleep mode in between paging time intervals 310. In a typical circuit-switched protocol such as 2G/3G wireless protocols, a typical paging time interval 310 is of the order of tens of milliseconds, while the time between paging time intervals 310 is typically of the order of hundreds of milliseconds.

### Session Initiation Protocol (SIP) Signaling

In VoLTE, paging protocols are not used since the LTE network is a packet network. VoLTE call signaling is instead provided by Session Initiation Protocol (SIP) based signaling. Session Initiation Protocol (SIP) is a signaling communications protocol that is commonly used for controlling communication sessions, such as voice and video calls, over Internet Protocol (IP) based networks. A primary feature of SIP is its ability to provide a signaling and call-setup protocol for IP-based communications that includes call processing features present in the public switched telephone network (PSTN). Such features include the familiar telephone-like operations of dialing a number, causing a telephone to ring, hearing ring-back tones or a busy signal. While SIP does not define these features, it does provide the call-setup and signaling functions necessary to ensure that multimedia sessions, e.g., voice and video calls can routinely be conducted over an IP network. Various versions of the SIP protocol have been standardized. For example, the Internet Engineering Task Force has standardized one version of the SIP protocol in RFC 3261.

SIP is a peer-to-peer protocol, with much of the necessary intelligence located in network endpoints, e.g., terminating devices. SIP is text-based and uses various mechanisms to reliably deliver messages between network participants. SIP messages may be broadly categorized into two categories, namely requests and responses to those requests. Requests are often characterized by the nature of the request, i.e., its “method.” One common SIP message is an INVITE, which is sent by a caller to request that another endpoint join a SIP session. For example, a caller would send this message to establish a media session, such as a conference or a voice call, between two participants.

As noted above, SIP uses various mechanisms to reliably deliver messages between network participants. In one such SIP mechanism, network participants maintain internal states and rely on the use of timers to determine whether the delivery of messages has been successful (or otherwise). The maintenance of these internal states and the use of timers enable SIP to reliably deliver messages despite having to rely on the use of unreliable transport mechanisms.

VoLTE relies on the use of SIP to accomplish voice calls and text messages over an LTE network. In a VoLTE system, an incoming call destined for a wireless communications device is signaled by SIP INVITE signaling. SIP signaling is sent over a default bearer of the packet data network (PDN), and the PDN may be an IP multimedia subsystem (IMS) PDN or a general purpose PDN. The INVITE messaging includes a three-way handshake. First, the initiator of the call to the wireless communications device sends out an INVITE request, followed by a response from the wireless communications device when it has successfully received the INVITE request. Finally, the initiator then sends an ACK message, which confirms a reliable message exchange with the wireless communications device. If the wireless communications device does not provide a response, the initiator will re-transmit the INVITE message after a period of time. Thus, in the case of unreliable transport protocols, such as those used in wireless communications, the SIP INVITE request may be retransmitted in accordance with various SIP timing requirements.

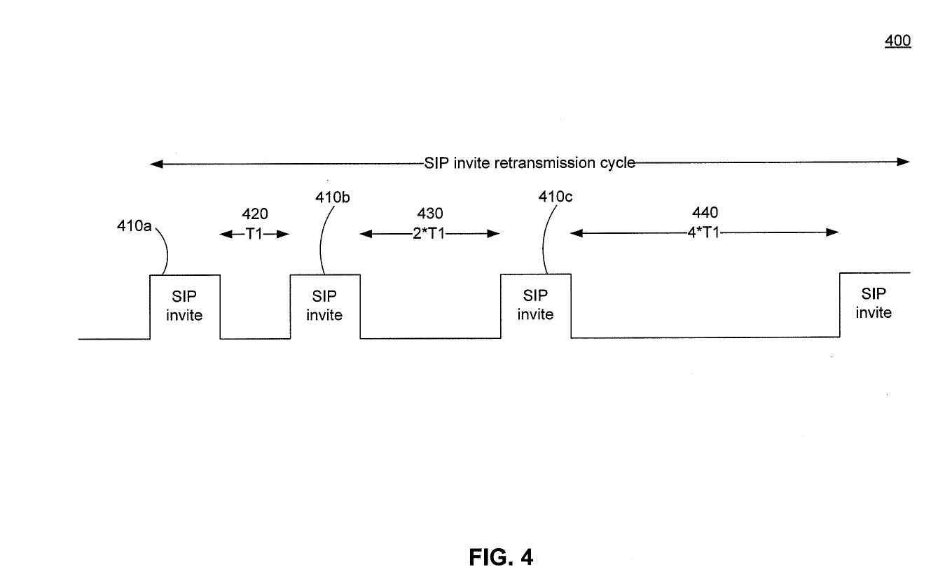

FIG. 4 illustrates the SIP INVITE timing requirements used in a VoLTE environment. In this environment, retransmission is assumed and the retransmissions are governed by the use of three SIP time values, namely the SIP T1 time, the SIP T2 time and the SIP T4 time.

The value of the SIP T1 time is defined in milliseconds and this value is based on an estimate of the Round Trip Time (RTT) of transactions between the two participants in the transaction. Thus, the time taken between sending out a request to the point of receiving a response forms the basis for setting the value of the SIP T1 time. By default, the value of SIP T1 time is set to 500 milliseconds. In the SIP protocol, a SIP INVITE message 410a is sent out to indicate an incoming telephone call for the wireless communications device. If a response is received from the wireless communications device, no retransmission of the SIP INVITE message is required. However, if no response is received during the time interval T1 420, the SIP INVITE message is retransmitted (as SIP INVITE message 410b) with an internal SIP timer value increased by a factor of 2 to establish time interval 430. In the case of the default SIP T1 value of 500 milliseconds, the duration of the internal SIP timer is doubled to 1000 milliseconds in the case of the first retransmission. In the continued absence of a response, retransmissions continue with the duration of the internal SIP timer being re-doubled with each retransmission. Thus, in the case of the second re-transmission, the duration of the internal SIP timer is re-doubled to 4*T1, which equals 2000 milliseconds in the case of the default T1 value of 500 milliseconds.

The value of SIP T2 time defines the maximum retransmit time of any non-INVITE request messages and INVITE responses. The default value of the SIP T2 time is set to 4000 milliseconds. Retransmissions of any non-INVITE request messages and the associated doubling of the internal SIP timer continues until the transmission reaches the SIP T2 time value.

The value of SIP T4 time denotes the time the network will take to clear messages between the participants in the SIP transaction. The default value of SIP T4 time is 5000 milliseconds. Values of the SIP timers typically scale with the initial value of the SIP T1 timer, if the default values are not used.

The use of the SIP timer methodology defines a maximum period of time during which an intended recipient can be absent, yet still receive the INVITE message if the intended recipient begins monitoring upon conclusion of this maximum period of time. As noted above, SIP T4 time denotes the time the network will take to clear messages between the participants in the SIP transaction. Thus, an INVITE message will be available in the network for at least the amount of time defined by SIP T4. Further, SIP guarantees retransmission of INVITE request messages that fail to receive a response. Such retransmissions continue to occur with a time interval between successive re-transmissions being doubled, beginning with a value set to SIP T1. Thus, a second retransmission occurs following an intervening interval of twice the value of SIP T1. Combining the above two concepts, an intended recipient of a SIP INVITE message can be absent from monitoring the LTE network yet still receive the SIP INVITE request message if the absence is limited to the larger of the above two times, namely the maximum of the value of twice SIP T1 and the value of SIP T4. Mathematically, this can be expressed as max (2*T1, T4).

### Exemplary Incoming Call Detection Approach

As noted above, it is desirable to be able to use a dual-SIM single RF wireless communications device and not miss incoming voice calls or text messages in either network to which the dual-SIM device is registered. The single RF chain requires the wireless communications device to monitor each network separately, as simultaneous monitoring of the two networks is not possible. Further, it is desirable that any approach that avoids missing an incoming voice call or text message be compatible with existing DRX procedures that minimize battery power consumption. The following discussion provides an exemplary incoming call detection approach for a dual SIM (one circuit-switched SIM, one packet-based SIM) single RF chain wireless communication device. Examples of the circuit-switched networks are 2G/3G, while an example of packet network is LTE using an SIP protocol (e.g., VoLTE), as described above.

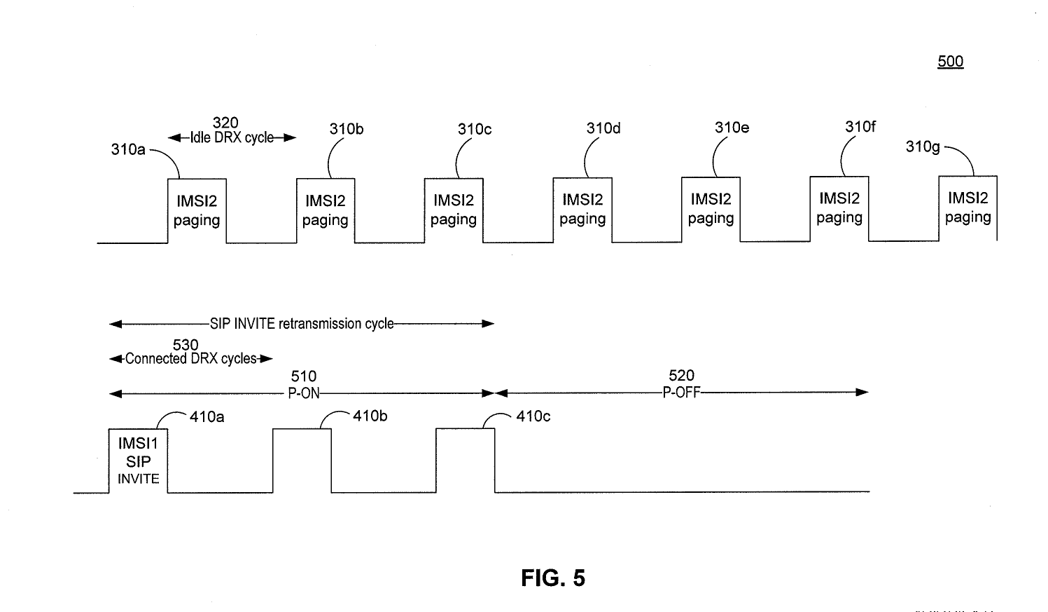

Based on the above SIP message retransmission procedures, the following approach substantially ensures that an incoming VoLTE call will not be missed. In order to be certain not to miss an incoming VoLTE call, a monitoring procedure is desired that is guaranteed to be active during the transmission of SIP INVITE messages associated with an incoming call. FIG. 5 illustrates an exemplary timing diagram of a coordinated circuit-switched paging monitoring procedure for an incoming call, and SIP INVITE monitoring procedure for voice over IP incoming call monitoring, in accordance with an embodiment of the present invention. The proposed monitoring timeframe is characterized by a duty cycle having a P-ON period 510 and a P-OFF period 520. During the P-ON period 510, the LTE radio channels associated with the LTE SIM have priority for the monitoring for SIP INVITE messages. During the P-OFF period 520, monitoring for SIP invite messages can be suspended, with priority now given to the monitoring of incoming calls on the circuit-switched network. Thus, during the P-OFF period 520, the wireless communications device can monitor for paging signals associated with an incoming call on the circuit-switched SIM. The value of P-ON period 510 is defined to be the larger of two values, namely the first value being twice the value of SIP T1, and the second value being the value of SIP T4, i.e., the maximum of (2xT1, T4). Similarly, the value of P-OFF period 520 is defined to be a maximum of the two times, twice the value of SIP T1, and the value of SIP T4, i.e., the maximum of (2xT1, T4). During the period P-OFF 520, the LTE monitoring can be suspended, and the monitoring priority of the wireless communication device switches to the circuit-switched SIM channels for a possible incoming call.

During the P-OFF period 520, a DRX cycle 320 associated with the circuit-switched protocol can be followed. In particular, the receiver circuitry can wake from a sleep mode at the DRX active portion of the DRX cycle 320, and thereby monitor the circuit-switched paging signals, should they be transmitted. Upon conclusion, the receiver circuitry can revert back to the low power state during the DRX sleep portion of the cycle. Thus, the power savings of a DRX cycle 320 can be realized within the P-OFF period 520. In an alternative embodiment, instead of reverting to the low power state during the DRX sleep portion of the DRX cycle 320, the wireless communication device can, for at least a portion of the DRX sleep portion of the DRX cycle, monitor the LTE channels.

During the period of LTE monitoring (P-ON period 510), circuit-switched incoming calls will not be missed despite the priority of monitoring being afforded to the LTE network. During the P-ON period 510, the wireless communications device can be configured as follows. The LTE network supports connected mode DRX cycles 530, where the connected mode DRX cycles 530 are synchronized with the delivery of LTE data, including an SIP INVITE message. As noted previously, DRX has both a DRX active period and a DRX sleep period. Thus, during the DRX active period, the wireless communication device monitors the LTE network. During connected mode DRX sleep periods associated with the LTE SIM, the wireless communications device may suspend monitoring of the LTE channels. Instead, paging signals associated with an incoming call on the circuit-switched protocol associated with circuit-switched SIM are available for monitoring in accordance with their known timeslots. Thus, during the P-ON period 510, a circuit-switched call will not be missed for the following reason. Should there be a timing conflict between a LTE DRX active period and the paging timeslot of the circuit-switched channel, priority is given to the LTE monitoring. However, the circuit-switched call will not be missed since the LTE DRX active period is sufficiently small that at least one of the repeated circuit-switched paging signals will be present following the conclusion of the LTE DRX active period. During LTE connected mode DRX active periods, priority remains with monitoring for an incoming call on the LTE network. Thus, if the timing of the paging channel associated with the circuit-switch SIM collides with a connected mode DRX active of the LTE SIM, priority is given to LTE SIM connected mode DRX active activity to check for SIP INVITE messages associated with an incoming LTE call.

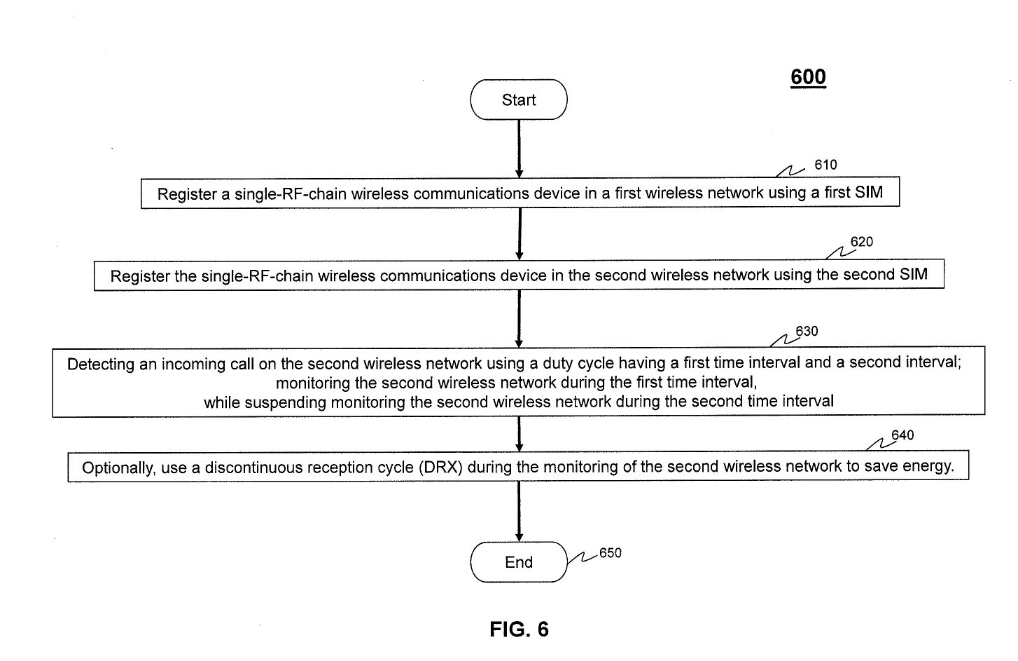

FIG. 6 illustrates a flowchart diagram of an exemplary dual-SIM incoming call detection method. Method 600 seeks to ensure that an incoming call will not be missed in a dual-mode single RF chain wireless communication device. It is to be appreciated the operations shown may be performed in a different order, and in some instance not all operations may be required. It is to be further appreciated that this method may be performed by one or more logic chips that read and execute these access instructions.

The process begins at step 610. In step 610, a wireless communications device is registered in a first wireless network using a first SIM, where the wireless communications device has a single RF chain. An exemplary implementation of step 610 may be the registration of wireless communication device 110 using SIM 112 in network 150.

In step 620, the wireless communications device is registered in a second wireless network using a second SIM. An exemplary implementation of step 620 may be the registration of wireless communication device 110 using SIM 114 in network 160.

In step 630, an incoming call for the second wireless network is detected using a duty cycle, where the duty cycle having a first time interval and a second time interval. The detection occurs by monitoring the second wireless network for the incoming call during the first time interval, while suspending monitoring the second wireless network during the second time interval. An exemplary implementation of step 630 may be the monitoring of wireless network 160 during P-ON 510, while monitoring wireless network 150 during P-OFF 520.

Optionally in step 640, a discontinuous reception (DRX) cycle to save energy usage of the wireless communications device may be used during the monitoring of the second wireless network. An exemplary implementation of optional step 640 may be the monitoring of wireless network 160 during P-ON 510 using a DRX cycle.

In step 650, method 600 ends.

The embodiments described, and references in the specification to “some embodiments,” indicate that the embodiments described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with particular embodiments, it is understood that it is within the knowledge of one skilled in the art to effect such feature, structure, or characteristic in connection with other embodiments whether or not explicitly described.

Some embodiments may be implemented in hardware, firmware, software, or any combination thereof. For example, logic layer 120 in FIG. 1 may be implemented as a computing device that can execute computer-executable instructions stored on a computer readable medium as follows. Some embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

### Exemplary Computer System Implementation

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

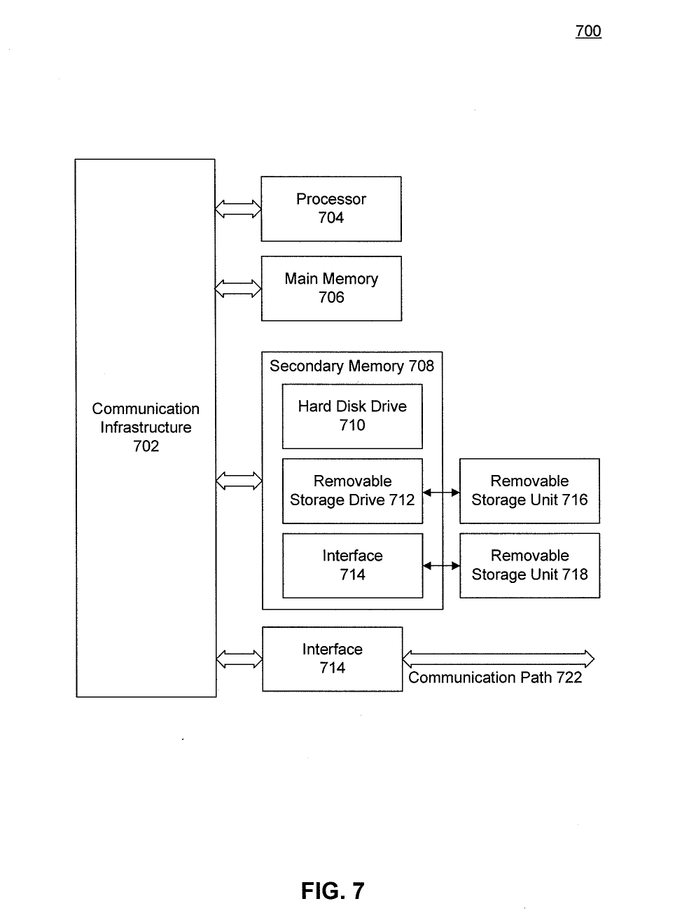

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 700 is shown in FIG. 7. One or more of the modules depicted in the previous figures can be at least partially implemented on one or more distinct computer systems 700; including, for example, controller module 230, baseband processor 220, and trigger modification module 244, link monitoring module 248, and trigger reception module 242.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the inventive subject matter such that others can, by applying knowledge within the skill of the art, readily modify and/or adapt for various applications such specific embodiments, without undue experimentation, without departing from the general concept of the inventive subject matter. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method, comprising:
registering a wireless communications device with a first wireless network using a first SIM, the wireless communications device having a single RF chain;
registering the wireless communications device with a second wireless network using a second SIM, wherein the second wireless network is a packet network; and
detecting an incoming call from the second wireless network using a duty cycle, the duty cycle having a first time interval and a second time interval, wherein the detecting includes monitoring the second wireless network for the incoming call during the first time interval and suspending monitoring the second wireless network during the second time interval.

2. The method of claim 1, wherein the second wireless network is a long term evolution (LTE) network.

3. The method of claim 1, wherein the first wireless network is a second-generation (2G) or a third-generation (3G) wireless network.

4. The method of claim 1, wherein monitoring the second wireless network includes:
using a discontinuous reception (DRX) cycle to save energy usage of the wireless communications device.

5. The method of claim 4, wherein using the DRX cycle includes placing the wireless communications device in a lower power state during a DRX sleep cycle.

6. The method of claim 4, wherein using the DRX cycle includes monitoring the first wireless network for a circuit-switched incoming call during a DRX sleep cycle.

7. The method of claim 1, further including:
monitoring a paging window associated with the first wireless network for an incoming call during the second time interval.

8. The method of claim 1, wherein a duration of the first time interval is based on timing of a session initiation protocol (SIP) retransmission protocol associated with the second wireless network.

9. The method of claim 1, wherein a duration of the second time interval is based on timing of a session initiation protocol (SIP) retransmission protocol associated with the second wireless network.

10. The method of claim 1, wherein the incoming call is signaled by a session initiation protocol (SIP) protocol associated with the second wireless network.

11. An apparatus, comprising:
one or more circuits configured to perform the following:
registering a wireless communications device in a first wireless network using a first SIM, the wireless communications device having a single RF chain;
registering the wireless communications device in a second wireless network using a second SIM, wherein the second wireless network is a packet network; and
detecting an incoming call from the second wireless network using a duty cycle, the duty cycle having a first time interval and a second time interval, wherein the detecting includes monitoring the second wireless network for the incoming call during the first time interval and suspending monitoring the second wireless network during the second time interval.

12. The apparatus of claim 11, wherein the second wireless network is a long term evolution (LTE) network.

13. The apparatus of claim 11, wherein the first wireless network is a second-generation (2G) or a third-generation (3G) wireless network.

14. The apparatus of claim 11, wherein the one or more circuits are further configured to monitor the second wireless network by:
using a discontinuous reception (DRX) cycle to save energy usage of the wireless communications device.

15. The apparatus of claim 14, wherein the one or more circuits are further configured to use the DRX cycle by placing the wireless communications device in a lower power state during a DRX sleep cycle.

16. The apparatus of claim 14, wherein the one or more circuits are further configured to use the DRX cycle by monitoring the first wireless network for a circuit-switched incoming call during a DRX sleep cycle.

17. The apparatus of claim 11, wherein the one or more circuits are further configured to perform the following:
monitoring a paging window associated with the first wireless network for an incoming call during the second time interval.

18. The apparatus of claim 11, wherein a duration of the first time interval is based on timing of a session initiation protocol (SIP) retransmission protocol associated with the second wireless network.

19. The apparatus of claim 11, wherein a duration of the second time interval is based on timing of a session initiation protocol (SIP) retransmission protocol associated with the second wireless network.

20. The apparatus of claim 11, wherein the incoming call is signaled by a session initiation protocol (SIP) protocol associated with the second wireless network.
